(19) United States
(12) Patent Application Publication
(10) Pub. No.: US 2006/0212386 A1
(43) Pub. Date: Sep. 21, 2006

(54) Credit scoring method and system

(76) Inventors: Dawn M. Willey, Newark, DE (US); Ye Zhang, Wilmington, DE (US); Krishna Gopinathan, San Diego, CA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/376,007

(22) Filed: Mar. 15, 2006

Related U.S. Application Data
(60) Provisional application No. 60/661,730, filed on Mar. 15, 2005.

(51) Int. Cl. G06Q 40/00

(52) U.S. Cl. 705/38

(57) ABSTRACT

A method for calculating probability distributions and probability scores associated with a consumer credit score is disclosed. The probability scores may comprise a bureau volatility score, and bureau error score, and/or a multi-bureau variability score.

### RELATED APPLICATIONS AND CLAIM OF PRIORITY

This application claims priority to U.S. Provisional Patent Application No. 60/661,730, titled “Credit Scoring Method and System,” filed Mar. 15, 2005, which is incorporated herein by reference in its entirety.

### BACKGROUND

1. Technical Field

The disclosed embodiments generally relate to the field of credit scoring methods and systems.

2. Description of the Related Art

Consumer credit reports are used by lenders, credit grantors and others to provide a guide as to whether a specific individual may be considered to be a good customer or a risky customer. A credit risk score attempts to condense a borrower's credit history into a single number, and such scoring has become widely accepted by lenders, credit grantors and others as a reliable means of credit evaluation. For example, they are often called “FICO® scores” when they are produced by Fair Isaac Corporation or “Experian bureau scores” when produced by Experian. However, other scoring agencies or entities can provide scores as well. For example, a credit risk score known as a VantageScore™ uses a score ranging from 501 to 990 and is currently marketed by all three major credit reporting agencies. These scores are developed based on data that is stored by consumer reporting agencies. The data stored by the agency may include, for example, account payment information on various accounts such as credit cards, retail accounts, mortgages, etc.; public records such as bankruptcy records and lawsuits; past due records; prompt payment records; amounts owed on various accounts; number of accounts with balances; lack of balances or specific types of balances; lengths of credit histories; lengths of time since account activity; information about new credit such as recently opened accounts; recent credit inquiries and time since credit inquiries; types of credit used; and other data.

Credit risk scores are calculated by using scoring models, empirically derived mathematical tables that assign points for different pieces of information that best predict future credit performance. Developing these models involves studying how thousands, even millions, of people have used credit. Score-model developers find predictive factors in the data that have been proven to indicate future credit performance. Models can be developed from different sources of data. Credit-bureau models are developed from information in consumer credit-bureau reports. Credit risk scores analyze a borrower's credit history considering numerous factors such as: late payments, the amount of time credit has been established, the amount of credit used versus the amount of credit available, length of time at present residence, employment history, negative credit information such as bankruptcies, charge-offs, collections, etc. A borrower may be declined for various reasons, such as, for example, a very thin credit file (i.e. little activity), too many credit inquiries in the file, too many outstanding revolving balances, too many open trades, a valid consumer dispute that has not yet been resolved, a high debt to income ratio, and missing trade information.

In the United States, there are three widely used general-purpose scores computed from data provided by each of three major credit bureaus—Experian, Trans Union and Equifax, and it is possible to obtain all three major credit bureau scores via one credit bureau request. Other credit scoring systems are available in other countries, as well as in the U.S. Some credit grantors use scores from one of these three bureaus, while other lenders may pull all three and use the median score. Credit reports are currently being used by entities other than traditional lenders and are now being used in areas such as insurance decisions, decisions whether to permit a customer to open a service account such as a cable account or cellular phone account, on-line brokerage transactions, landlord-tenant transactions, and employment decisions. Thus, credit reports may impact numerous areas of a consumer's financial life, such as, for example, through a denial of credit, a higher cost of credit, difficulty securing housing and services, and employment decisions.

Credit risk scores are essentially probability scores rather than definitive decision outcome scores, and while they are often fairly accurate for a period of time, there are several problems with current credit scoring methods. The scores are often not uniform among agencies, are often not accurate long-term predictors of credit risk, and do not take into account the chance that there may be errors that, when brought to a consumer's attention, may cause a change in the credit score. In addition, credit scores are sometimes not even uniform within the same agency—for example a consumer with a score of 680 supported by twelve tradelines and fifteen years of credit history may have very different dynamics relative to a consumer with a score of 680 supported by only three tradelines and only two years of credit history. Because these scores rely on only particular data that is on record with the agency doing the reporting, it is common for an individual consumer's score to vary across agencies. This affects consumers in important ways because often, a decision whether to do business with a consumer will depend on the individual's score. Thus, the consumer's ability to get a loan, or the consumer's actual interest rate charged, may depend on the agency from which the lender requests a credit report. For example, if an individual has a score over a predetermined threshold, such as 700, a lender may be willing to grant a loan to the consumer. If the score dips below another threshold such as 680, then the lender may agree to do business with the consumer but charge a higher interest rate. If the credit score is below 680, the lender may refuse to do business with the consumer.

In addition, current scoring methods use an average based on data that is available over a specific period of time. An example is, “Total number of credit inquiries in the last 30 days”. Since certain transactions, such as on-line lending transactions or on-line insurance brokerage transactions may trigger multiple credit inquiries, a single request on such a website may cause an individual's credit score to decrease significantly because a large number of credit inquiries may be generated by this one consumer action.

It is also not uncommon for there to be errors in a credit report, due to, for example, data entry errors, outdated legacy credit underwriting rules, limited system capabilities to handle rule changes, limitations and costs associated with improving data quality, a large number of non-traditional firms requesting reports, etc. There are, therefore, avenues for consumers to dispute a credit report with the lender or service provider. A valid and successful dispute may result in changes in tradelines, or the data used to compute a credit score, thus also effecting a change in the credit score itself. Currently, there are no methods for evaluating the probability that a dispute will be filed, and if such a dispute will result in a change in a tradeline.

Accordingly, an improved method consistent with scoring a consumer for credit decisions in the presence of errors, data variability, and other sources of volatility is desirable. The disclosure contained herein describes attempts to address one or more of the problems described above.

### SUMMARY

In an embodiment, a method of assessing a credit risk score includes creating training data from historic credit data, wherein the historic credit data includes a credit risk score of a consumer. The method also includes developing a first set of tokens from the training data, analyzing current credit data for the consumer to develop a second set of tokens, wherein the second set of tokens is a subset of the first set of tokens, and using the second set of tokens to develop a quality score for credit risk score. The quality score is indicative of the quality of the consumer's credit risk score. The historic credit data may include, for example, tradeline information, consumer or business attribute information, public record data credit inquiry data, bureau alert data, or non-tradeline information. Optionally, determination of the quality score may comprise estimating a probability distribution and aggregating its components into a probability score.

In some embodiments, the quality score comprises a volatility score that predicts variability of the credit risk score over a period of time in the future. The volatility score may comprise an expected value of the credit risk score's statistical variance over at least one future span of time. In other embodiments, the quality score comprises an error score that determines a likelihood of occurrence of a credit dispute. In other embodiments, the quality score comprises an error score that determines whether the dispute will result in a change in the consumer's credit file. In other embodiments, the quality score comprises a variability score that determines the variability of the consumer or business credit score among credit reporting agencies.

In other embodiments, the method also includes combining the quality score with individual consumer data to determine credit risk score stability and consumer dispute potential. It may also include using the quality score to develop underwriting rules for credit approval. It may also include generating at plurality of reason codes for the quality score.

In another embodiment, a method of assessing the volatility of a plurality of a credit risk scores includes creating training data from historic credit data, wherein the historic credit data includes data for a plurality of consumers over a plurality of time periods; predicting a volatility based on the training data; and using the volatility to identify a quality score for a credit risk score of one or more of the consumers.

In another embodiment, a method of assessing a credit risk score includes identifying historic credit data, wherein the historic credit data includes a consumer credit risk score of a consumer; and developing a quality score based on the historic credit data, wherein the quality score is a prediction of a volatility of the consumer credit risk score over a period of time. The development of a quality score may comprise predicting an expected distribution of the score over a period of time and aggregating components of this distribution into a probability score.

In another embodiment, a method of assessing a credit risk score includes identifying historic credit data, wherein the historic credit data includes a consumer credit risk score of a consumer; and developing a quality score based on the historic credit data, wherein the quality score is a prediction of a variability of the consumer credit risk score among a plurality of agencies. The development of a quality score may comprise predicting a distribution of the score over a period of time.

### BRIEF DESCRIPTION OF THE DRAWINGS

FIG. 1 depicts an overall flowchart illustrating an exemplary embodiment of a method of determining three quality scores (volatility score, error score and variability score) of a consumer credit risk score.

FIG. 2 depicts a flowchart illustrating an exemplary embodiment of a method of determining a bureau volatility score.

FIG. 3 depicts a flowchart illustrating an exemplary embodiment of a method of determining a bureau error score.

FIG. 4 depicts a flowchart illustrating an exemplary embodiment of a method of determining a bureau multi-variability score.

FIG. 5 depicts an exemplary process of applying a bureau volatility score in credit processing during underwriting borderline credit bureau accounts or credit extension requests.

FIG. 6 depicts exemplary applications of bureau volatility score.

FIG. 7 depicts an exemplary process of applying a multi-bureau variability score.

FIG. 8 depicts an exemplary process of applying an error score.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

The present invention as stated herein relates to improved methods and systems for scoring consumer credit. However, the term “consumer” is only used as an example, and all algorithms herein may apply to other types of entities including, but not limited to, corporations, companies, small businesses, and households.

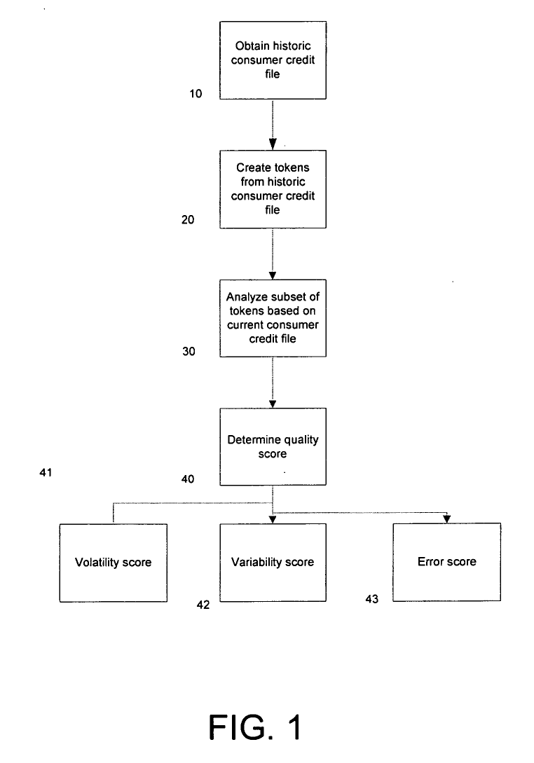

Referring to FIG. 1, there is shown an overall flowchart illustrating a method of computing quality scores and/or probability distributions associated with a consumer credit risk score. In this method, a mathematical model is designed and trained based on a dataset or developmental sample of bureau files containing historical credit data. A consumer credit file comprising strings of alphanumeric characters is created from the consumer's historical credit data acquired from one or more credit bureaus or other entities 10, where a tokenization algorithm is applied to parse the raw credit file data into preferably well-formatted and labeled canonical data. The credit file may include a credit risk score for a consumer, optionally created by scoring agency or a credit reporting agency.

A stream of tokens, or primitive blocks of structured text, is created 20. Tokenization identifies the different lexical elements in an arbitrary string of text and converts the string to a series of tokens based on business domain knowledge. Tokens may represent numeric or symbolic data in a variety of forms—for example, one possible tokenization might involve breaking up a numeric variable into distinct ranges and assigning each range a specific token. The historical credit file data may include information on multiple tradelines, such as, for example, the amount, open date, and balance of a loan vs. credit line or original loan amount, payment history, type of loan (e.g. auto, installment, mortgage, etc.). Examples of other data may include, but is not limited to, consumer attribute information, such as name, address, social security, date of birth, and employer; public record data such as liens, court judgments, tax liens, collection accounts, and bankruptcy filings; credit inquiry data such as the date and lender/credit grantor/service provider that made a credit inquiry; and bureau alert data such as an alert that the consumer may have a credit file that is potentially mixed up with another individual, potential fraud concern, consumer bankruptcy, or the potential that the consumer in question is deceased. The historical credit file data may also include non-tradeline information, such as, for example, personal data such as age, gender, zip code, educational level, and annual income. Applying tokenization modeling to analysis of the historical credit file data allows some level of subjective heuristics as well as consolidation of relatively unimportant information (i.e. white noise). Application of tokenization modeling may be better understood by considering the following example.

Tokenization Modeling Example:

Take the following tradeline as an example: a home mortgage opened in 2004, where the loan amount is $19,000 at a rate of 4.875% for 30 years, and this consumer has one late payment. The Tokenization Model may include the following information: loan type, amount, open time, rate, loan time span, one late payment. In modeling this data, the model's sensitivity to detail is carefully balanced with its ability to generalize at a higher level. For example, the difference between a $200,000 mortgage and a $150,000 mortgage may not be significant for predicting a future credit score variation for a person with a very high income. However, the difference may be highly significant for a person struggling to make ends meet.

Sub-tokens may be used to denote different bands of loan amount. For example, mortgage amount<=$150,000 may be denoted as “A1,” and $150,000<mortgage amount<=$200,000 may be denoted as “A2,” etc. Simultaneously, a different set of tokens may be used to denote smaller bands when associated with a lower income consumer. Similarly, “home mortgage” may be denoted as “H,” and 30-year time span for mortgage loan may be denoted as “S1,” etc. In this example, the above tradeline may be represented as a token:H-A2-2004-5-S1-1. Using this method, a bureau data file B may be modeled as a set of tokens (b₁, b₂, . . . , bₙ). Bureau data file B may also include non-tradeline tokens, such as personal data.

In this example, the notation may be subjective or objective, as the modeler may adjust the resolution based on the data. Algorithms such as, for example, CART and CHAID may provide data-driven tokenization, while experienced modelers may create their own constructs to better model the data.

Returning to FIG. 1, after tokenization has been applied and a set of tokens has been created, the tokens are analyzed by applying a mathematical algorithm to the set of tokens and a current consumer credit file 30. The mathematical algorithm may be, for example, a Bayesian algorithm, and it may be used in conjunction with logistic regression, classification and regression trees (CART), neural networks, and/or other modeling techniques as needed. The current consumer credit file yields a subset of the tokens that are analyzed to determine a quality score associated with the consumer's credit risk score 40.

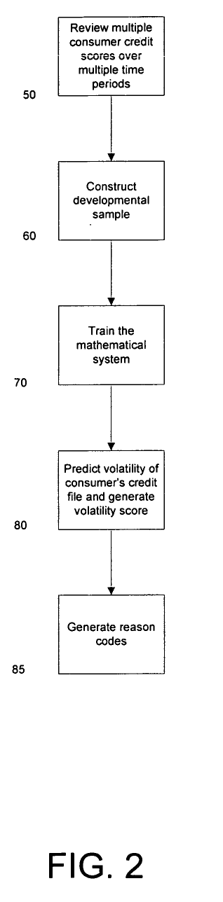

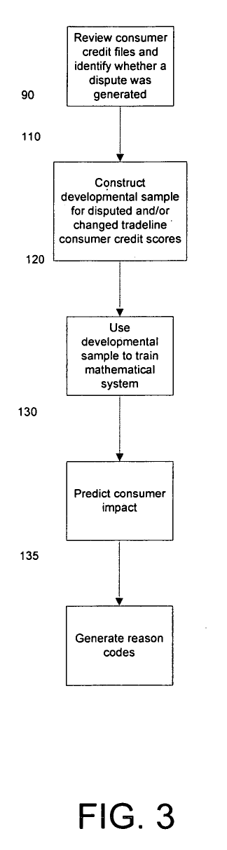

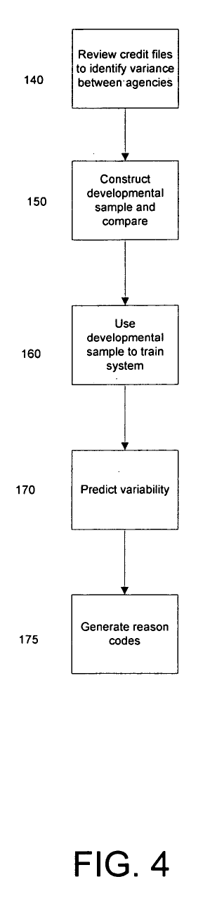

The quality score may include a numeric score or a distribution over time. The quality score may comprise, for example, a volatility score 41 that predicts variability of the consumer credit score over a span of time and/or the expected value of the consumer credit risk score's statistical variance over a future span of time. Additional detail about calculation of the volatility score 41 is described below in the discussion relating to FIG. 2. The quality score may also include an error score 42 that is indicative of the likelihood of occurrence of a credit dispute and/or whether the dispute will result in a change in the consumer credit file. Additional detail about calculation of the error score 42 is described below in the discussion relating to FIG. 3. The quality score may also include a variability score 43 that determines the variability of the consumer credit score among score computing agencies. Additional detail about calculation of the volatility score 43 is described below in the discussion relating to FIG. 4. The model to determine these quality scores may involve first determine the probability distribution and then aggregating components of the probability distribution to compute the final score. Each of these quality scores may adopt a standard probability representation [0,1], but may instead or in addition adopt other representations. By first determining the probability distribution, the model is not limited to only one single score, instead complete statistical attributes (such as standard deviation, medium, variance, etc.) of a consumer's credit profile can be derived from the model.

Bureau Volatility Score

As depicted in FIG. 2, additional details show how a bureau volatility score may be constructed to determine variability of a consumer's credit file and credit risk score over a span of time. Multiple individuals' scores over multiple time periods are reviewed to determine the distribution of all changes in the scores over a specified period of time, with particular focus on those which had significant changes up or down in score 50. A developmental sample is constructed, where the sample comprises multiple consumer's credit files at multiple periods of time, such as, for example, 100,000 consumers at time X and at time X+12 months 60. While the primary purpose is to identify the likelihood and distribution of significant changes, nevertheless if certain data elements have significant changes, then those data elements might be discarded if, for example, an aberration occurred during that time period. The performance period for measuring the volatility may be selected to be any time period, such as three months, six months, one year, two years, etc. The developmental sample is tokenized and evaluated for significant changes (i.e. up or down) in the consumer's credit score. Thus, an aberration such as a single transaction that deceivingly triggers multiple credit inquires thereby incorrectly reducing traditional scores may not be viewed as adverse to a consumer's credit score, and may instead correctly predict the volatility of the consumer's credit rather than further propagate the error in the traditional scores.

After constructing the development sample, it is used to train a mathematical system (e.g., a system based on Bayesian model) 70. The trained mathematical system is then applied to the tokenized consumer credit file data to predict the volatility, or the likelihood of significant changes in a specified time period, of the consumer's score, as well as the expected value of the score's statistical variance over a future X-month period of time 80. Reason codes associated with these predictions, or explanations for the predicted volatility, may also be generated in addition to the prediction of volatility obtained from the trained mathematical system 85. To generate reason codes, the individual impact of each token in the tokenized consumer credit file is separately computed in such a manner that the sum of each individual impact adds up to the overall prediction of volatility. These individual impacts are then rank ordered and the tokens having the largest impact are identified as the reasons or explanations for the predicted volatility. These reasons, termed “reason codes ”herein, subsequently may be utilized to augment decisions made using the volatility score. For example, high volatility due to lack of credit history may lead to a very different credit action than high volatility due to an inconsistent pattern of data within a credit file having a rich credit history.

Bureau Error Score

As depicted in FIG. 3, additional details show how a bureau error, or consumer impact score, may be constructed to determine the adverse consumer impact of the errors in a consumer's credit file by considering the likelihood of occurrence of a credit dispute, and the farther likelihood that such a dispute will result in a change in the consumer's credit file. A group of consumer credit files are reviewed to determine whether the consumer reviewed the file and if so, whether a dispute was generated 90. A developmental sample is constructed, where the sample comprises a group of consumer credit files (optionally including credit scores) that have been reviewed by the consumer 100. The developmental sample is tokenized and evaluated for consumer credit files that have been reviewed, been the subject of a dispute and, of those consumer credit scores, which credit files have a changed tradeline as a result of the dispute 110. The stated developmental sample is used to train a mathematical system (e.g., a system based on Bayesian model) 120. The trained mathematical algorithm is then applied to the tokenized consumer credit file data to predict the adverse consumer impact of the errors in the consumer's file and score 130 along with reason codes 135, wherein the reason codes may be determined similar to the manner described above under “Bureau Volatility Score.”

This bureau error score and its corresponding reason codes may be used as criteria considered while evaluating a loan application. For example, a consumer with the name of “John Smith” and a long history of perfect credit may have ten tradelines in good standing, all fully paid up, low utilization of available credit, and a single mortgage tradeline with a high balance and a chargeoff. This consumer might get a high error score along with reason codes such as, for example, “Possible name confusion,” “Unlikely delinquency sequence,” and “Chargeoff with unusually low utilization on other trades.”

Multi-bureau Variability Score

As depicted in FIG. 4, a multi-bureau variability score may be constructed to determine the variability of the credit risk score of a consumer across two, three or more credit reporting agencies at a point in time. If the score is highly variable between two or more agencies or bureaus, there may be a problem with one bureau's data. Multiple individuals' credit files from the same point in time from each credit reporting agency are reviewed to determine the extent of variance among the reports on the same consumer across the different credit reporting agencies 140. A developmental sample is constructed based on each credit reporting agency's consumer files to identify which consumers are most likely to have significant variance across the other credit reporting agencies at the same point in time 150. The developmental sample is tokenized and evaluated for its ability to predict the variance across the other credit reporting agencies' files at the same point in time, and used to train the mathematical system 160. The trained mathematical algorithm, such as one based on a Bayesian algorithm, is applied to predict the variability of consumer credit scores and the likelihood of obtaining significant new information for the consumer from another credit agency 170. Reason codes may be generated 175 in a manner similar to those described above. If the score is highly variable between two or more agencies or bureaus, there may be a problem with one bureau's data.

The method for computing the Multi-bureau Variability score may include components that are frequently updated by pulling a sample of records from all three credit reporting agencies. For example, the algorithm may pull a random sample of 1000 consumers' records from all three bureaus every day, and update its variables and/or model estimates based on the similarities and differences among these 1000 consumers. Having pulled such information, the trained mathematical algorithm will determine predicted variability scores along with reason codes, preferably determined as described herein under “Bureau Volatility Score.” As an example, if on a given day, Bank X's data feed to all three bureaus is misapplied at Bureau Y, all customers of Bank X would have high variability across the three bureaus. This high variability specifically associated with customers of Bank X might be detected by the model using a random sample of 1000 bureau records. The multi-bureau variability model may generate a high variability score for these customers, along with reason codes such as “Bank X data error.” The bureau variability score may also be used directly by the consumer as a red flag that there may be a problem with their credit bureau file, indicating that the consumer should review his/her file for errors or pull the score from other agencies.

Bayesian Algorithm Example:

Application of the Bayesian algorithm may be better understood by considering the following example. In this example, the modeling and training is described using the bureau volatility score. The bureau error score and the multi-bureau variability score may be modeled in a similar way.

Continuing with the previous example, where B represents a consumer's current bureau file, C₀ represents the bureau credit score, such that the probability that this consumer's bureau credit score becomes C₁ after time period T may be represented as P(C₁|B, C₀, T). The model may be constructed on multiple fixed time spans, such that in T months, the probability of score change may be represented as P(Cₜ₁|Bₜ₀, Cₜ₀, Tₜ₀). Based on Bayesian rule,

$$P ( {C}_{t1} \vert {B}_{t0} , {C}_{t0} ) = \frac{P ( {C}_{t1} , {B}_{t0} , {C}_{t0} ) ,}{P ( {B}_{t0} , {C}_{t0} )}$$

where P(Cₜ₁, Bₜ₀, Cₜ₀)=P(Bₜ₀, Cₜ₀|Cₜ₁) P(Cₜ₁). Assuming Cₜ₀ is computed from Bₜ₀ using a well defined function, then P(Bₜ₀, Cₜ₀)=P(Cₜ₀|Bₜ₀)P(Bₜ₀)=P(Bₜ₀). Then the above equation (1) becomes:

$$P ( {C}_{t1} \vert {B}_{t0} , {C}_{t0} ) = \frac{P ( {B}_{t0} \vert {C}_{t1} ) P ( {C}_{t1} )}{P ( {B}_{t0} )}$$

In this example P(Cₜ₁|Bₜ₀, Cₜ₀) is calculated according to a Bayesian estimation approach.

According to the above equation and assuming that bureau data B comprises mutually independent tokens,

$$\begin{matrix}P ( {C}_{t1} \vert {B}_{t0} , {C}_{t0} ) = \frac{P ( {b}_{1} , {b}_{2} , … , {b}_{n} \vert {C}_{t1} ) P ( {C}_{t1} )}{P ( {b}_{1} , {b}_{\underline{2}} , … , {b}_{\underline{n}} )} \\ = \frac{P ( {b}_{1} \vert {C}_{t1} ) , P ( {b}_{2} \vert {C}_{t1} ) , … , {b}_{2} , … , P ( {b}_{n} \vert {C}_{t1} ) P ( {C}_{t1} )}{P ( {b}_{1} ) P ( {b}_{2} ) , … , P ( {b}_{\underline{n}} )}\end{matrix}$$

If the data set is large _{enough} and it is assumed that prior probability P(Cₜ₁) is not fluctuated too much over time, prior probability P(Cₜ₁) may be estimated as the number of consumers with a bureau score of Cₜ₁ divided by the total size of the data set. Similarly, P(bᵢ) can be estimated as the number of occurrences of bᵢ divided by the total size of the data set.

An estimate of P(bᵢ|Cₜ₁) is also needed. An m-estimate method may be used to estimate the conditional and prior probability of the tokens. M-estimate may be viewed as mixing the sample population with m uniformly distributed virtual samples. In this algorithm, m=1 and the probability of a token in the virtual example is 1/K, where K is the number of unique tokens in the training, or developmental data set. Thus,

$$P ( {b}_{i} \vert {C}_{t1} ) = \frac{N ( {b}_{1} , {C}_{t1} ) + 1 / K}{N ( {C}_{t1} ) + 1}$$

where N(Cₜ₁) is the number of bureau files with a bureau score of Cₜ₁ and N(b₁, Cₜ₁) is the number of occurrences of b₁ in bureau files with a bureau score of Cₜ₁. Additionally, a filter may be applied to remove tokens that may not be good indicators of bureau score volatility for the bureau files in which they occur so that the volatility prediction will not be affected by the accumulation of noise.

Alternatively or in addition, other mathematical methods, such as the Bayesian predicate method, may be used, particularly when the training or developmental set is only a small fraction of the complete data.

Token degeneration may be applied if an exact match for a token cannot be found, such that the model treats it as if it were a less specific version. The algorithm's automatic use of a “less specific version” has an embedded hierarchical character to it, where the algorithm “raises its sights” to the next higher level if it cannot operate at the most detailed level. The algorithm's flexibility lies in its ability to simultaneously embed multiple different hierarchies and choose the best one for a given situation.

Linear dependence among the tokens may be addressed by using, for example, factor analysis coupled with logistic regression. Non-linear dependence may be addressed using, for example, simultaneous k-way tokenization and/or tree-based interaction detection and tokenization with Bayesian estimation.

One or more of any of the embodiments described above may be combined to calculate an improved consumer score. In addition, any or all of the scoring methods above may be used in conjunction with traditional credit scoring methods, such as “FICO” scores.

Application of the Quality Scores

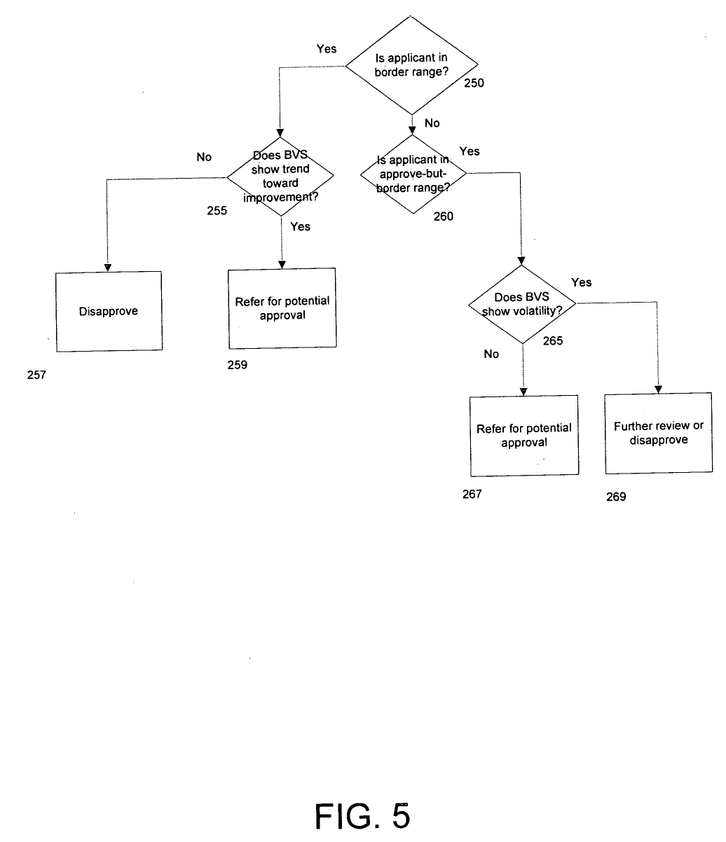

FIGS. 5, 6, 7 and 8 depict exemplary application areas of proposed bureau volatility, variability and error scores. Furthermore, additional information about the consumer, such as data derived from the credit bureau, demographic data, credit application data, other bank data and/or non-traditional consumer credit data may be modeled into a tokenization model and/or be used in combination with any of the quality scores to determine whether a consumer's credit risk score will remain relatively stable over time and across credit reporting providers or will have a higher potential for a consumer dispute of the bureau score accuracy. For example, a consumer who is in his or her last year of graduate school may have a low credit risk score based on previous customer demographics and/or credit history. However, because (in this example) the consumer is to be expected to graduate within a year and likely be employed in a high salary position, the consumer's credit risk score may be adjusted upward based on other reflective attributes such as presence of a student loan, age of credit file relative to types, number of tradelines and loan amounts of tradelines to account for the brevity of the expected period of risk.

Applications of the Bureau Volatility Score

The bureau volatility score may have many applications, including but not limited to the following exemplary applications, new credit, thin file applicants, credit extension, high risk account monitoring, collection account treatment, credit bureau volatility reason codes, and threat identification. Further details of each application are described below.

A) New Credit

Credit applications classified as “New Credit” may be an application for a loan, or application for a service (e.g. phone service), etc. FIG. 5 depicts an exemplary process of applying a bureau volatility score in credit processing during underwriting borderline credit bureau accounts. The volatility score may be incorporated into the credit underwriting process to further evaluate credit approvals and declines on the margin. Credit applications based on volatility and direction of volatility may be treated differently and sent for further review and potentially modifying the credit decision if volatility was not taken into consideration.

If, for example, during the credit underwriting process an applicant for a loan was on the border range of traditional underwriting approval criteria 250 and the applicant's bureau volatility was moving towards an improving direction (higher score) 255, underwriting rules may be developed that may have the loan referred for additional review for potential approval 259 vs. disapproval 257. Conversely, if an applicant just met the approval criteria 260 but had high credit bureau volatility 265 in either direction (high potential for up or down movement) or in downward direction, the loan may be sent for additional review to consider if the loan should be declined 267 vs. approved 269. The same concept may be applied to those more volatile “borderline” credit applicants who are approved but approved at a lower loan level or priced at a higher annual percentage rate of interest (“APR”) because of the volatility.

B) Thin File Applicants

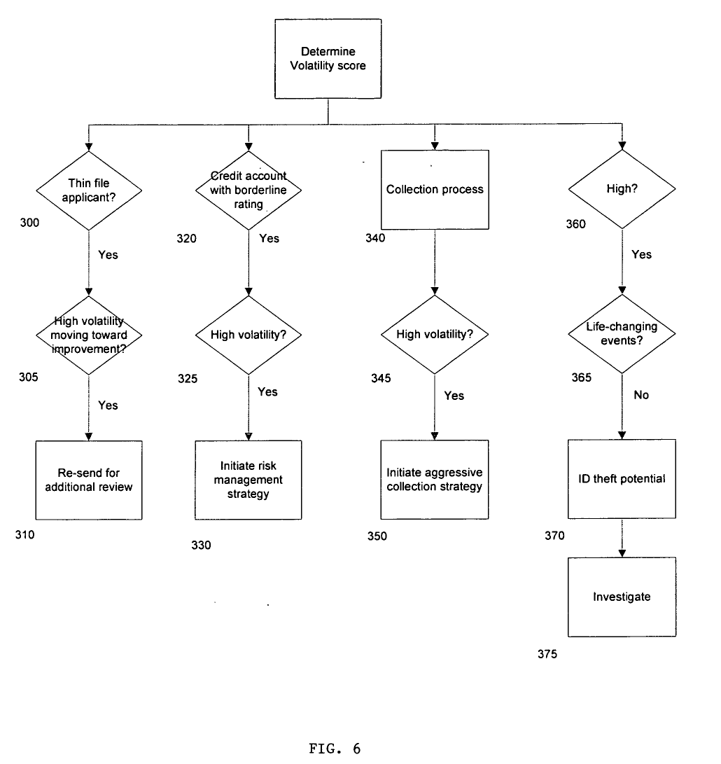

Referring to FIG. 6, credit applications classified as “Thin File” 300 are typically systemically declined based on credit grantors' criteria (e.g., all trades less than three years old or credit bureau has less than three trades). In this case, if an applicant has a high volatility score moving towards an improving direction 305, the applicant's case may be sent for additional review for potential approval 310.

C) Credit Extension

Credit applications classified as “Credit Extension” may be an application for an extension of credit on a loan, or application for extension of credit for a service (e.g. phone service), etc. The volatility score may be incorporated into the credit underwriting process to further evaluate credit extension decisions from existing account consumers regarding approvals and declines on the margin. Credit extension requests based on volatility and direction of volatility may be treated differently and sent for further review, potentially modifying the credit decision if volatility was not previously taken into consideration.

Referring again to FIG. 5, if, for example, during the credit decision process an existing account consumer was on the border range 250 of traditional underwriting approval criteria, and if that customer's bureau volatility was moving towards an improving direction 255 (higher score), underwriting rules may be developed that would have the credit grantor perform additional review for potential approval 259. Conversely, if an existing account consumer just met the approval criteria 260 but had high credit bureau volatility 265 in either direction (high potential for up or down improvement) or downward, the credit grantor may perform additional review 269 to consider if the loan should be declined vs. approved. The same concept could be applied to those more volatile “borderline” credit extension decisions which are approved but approved at a lower loan level or priced at a higher APR because of the volatility.

D) High Risk Account Monitoring

Referring again to FIG. 6, in an exemplary process of applying the volatility model to high risk accounts. Credit accounts (i.e. loan or service) on file that have a borderline credit bureau score 320 may be evaluated in conjunction with the credit bureau volatility score. If the bureau volatility score 325 indicates a significant change in credit score, such as, for example an indication of downward volatility where the total credit picture begins to appear to be at risk, one or more high risk account management strategies 330 may be invoked that may include treatments such as reducing credit exposure (e.g., credit line decrease, limiting extension of service or other credit) or contacting the consumer to further evaluate the risk picture.

E) Collection Account Treatment

In an exemplary process of applying a bureau volatility score in collections account treatments, collection account strategy and treatments may take the credit bureau volatility score into consideration when defining collection efforts, collection repayment programs, interest reduction offers and/or settlement offers 340. If the bureau volatility score indicates a significant change 345 in credit score, such as, for example an indication of downward volatility where the total credit picture begins to appear to be at risk, the account may be treated as a high risk account and more aggressive loss avoidance treatment measures 350 may be put in place, such as a greater degree of collection effort, offers for lower reduced payment, and/or offers for interest programs as well as lower or multi-payment settlement programs for the purpose of loan or account loss avoidance.

F) Credit Bureau Volatility Reason Codes

Credit bureau volatility reason codes may be used in concert with the credit bureau volatility score for the development of specialized credit treatment strategies used in the determination of approvals, declines or the need for additional investigation.

G) Threat Identification

The bureau volatility score may be used to red-flag potential identity theft threats. For example, if at certain time a consumer's bureau volatility score is high 360 (meaning that the credit risk score is unstable), and further investigation 365 does not reveal any life changing events for the consumer, the consumer may be flagged as a potential identity theft victim 370 and further investigation may be initiated 375. Similarly, a high error score may be used to trigger potential identity theft investigation.

Applications of the Multi-bureau Variability Score

The multi-bureau variability score many have applications similar to the volatility score described above. The multi-credit bureau variability score may have, but is not limited to, the following exemplary applications:

A) New Credit

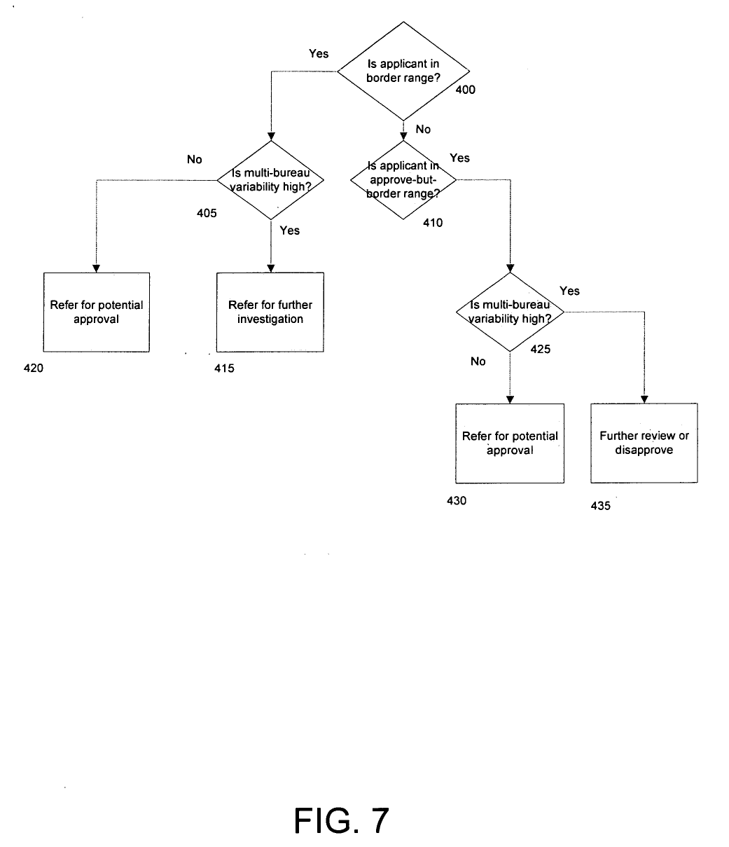

Credit applications classified as “New Credit” may be an application for a loan, or application for a service (e.g. phone service), etc. FIG. 7 depicts an exemplary detailed process of applying a bureau variability score during the new credit underwriting process.

If, for example, an applicant was on the border range 400 of traditional underwriting approval criteria and the applicant's multi-bureau variability was high 405, meaning there was a potential large variance in bureau score outcomes across the credit bureaus, additional credit investigation may be necessary, such as obtaining cross bureaus (i.e. pulling credit bureaus and bureau scores from other providers), pulling a tri-bureau, debit bureau or alternative credit evaluation sources. Underwriting rules may be developed that may have these credit applicants referred for additional review 415 for potential approval, while optionally credit applicants with low multi-bureau variability may be referred for potential approval 420. Conversely, if an applicant just met the approval criteria 410 and that applicant's multi-bureau variability was high 425 (meaning there was a potential large variance in bureau score outcomes across the credit bureaus), additional credit investigation may be necessary, such as obtaining cross bureaus (pulling credit bureaus and bureau scores from the other providers), pulling a tri-bureau, debit bureau or alternative credit evaluation sources. The loan may be disapproved or sent for additional review to see if the loan should be declined vs. approved 435. Border applicants with low variability may be referred for potential approval 430.

B) Credit Extension

Similarly, referring again to FIG. 7, credit applications classified as “Credit Extension” may be an application for an extension of credit on a loan, or application for extension of credit for a service (e.g. phone service), etc. During the existing customer credit extension underwriting process, if an customer was on the border range 400 of traditional underwriting approval criteria and that customer's multi-bureau variability was high 405 (meaning there was a potential large variance in bureau score outcomes across the credit bureaus), additional credit investigation may be necessary, such as obtaining cross bureaus (i.e. pulling credit bureaus and bureau scores from the other providers), pulling a tri-bureau, debit bureau or alternative credit evaluation sources. Underwriting rules may be developed that may have these applications referred for additional review 415 for potential approval, while optionally applicants with low multi-bureau variability may be referred for potential approval 420. Conversely, if an existing customer credit extension request indicated a customer that just met the approval criteria 410 and that customer's multi-bureau variability was high 425 (meaning there was a potential large variance in bureau score outcomes across the credit bureaus), additional credit investigation may be necessary, such as obtaining cross bureaus (i.e. pulling credit bureaus and bureau scores from the other providers), pulling a tri-bureau, debit bureau or alternative credit evaluation sources. The application may be disapproved or sent for additional review to see if the loan should be declined vs. approved 435. Border applicants with low variability may be referred for potential approval 430.

C) Credit Bureau Variability Reason Codes

The credit bureau variability reason code may be used in concert with the credit bureau variability score for the development of specialized credit treatment strategies for the determination of approvals, declines or the need for additional investigation.

Applications of the Credit Bureau Error Score

The credit bureau error score may have, but is not limited to, the following exemplary applications:

A) New Credit

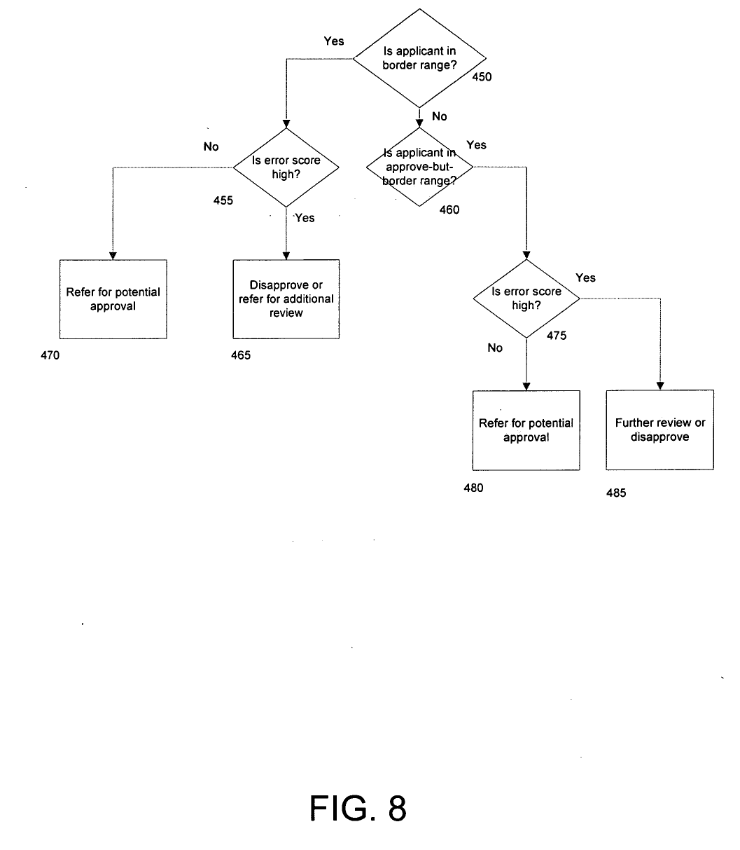

Credit applications classified as “New Credit” may be an application for a loan, or application for a service (e.g. phone service), etc. FIG. 8 depicts an exemplary process of applying the bureau error score during the new credit underwriting process. The error score may be incorporated into the credit underwriting process to further evaluate credit approvals and declines on the margin.

If, for example, an applicant was on the border range 450 of traditional underwriting approval criteria and the applicant's bureau error score was high 455, meaning a large potential for errors in an applicant's credit file that may trigger a credit dispute, additional credit investigation may be necessary, such as obtaining cross bureaus (i.e. pulling credit bureaus and bureau scores from other providers), pulling a tri-bureau, debit bureau or alternative credit evaluation sources. Underwriting rules may be developed that may have these applications disapproved or referred for additional review or investigation for potential approval 465, while optionally low error scores may result in potential approval without such additional review 470. Conversely, if an applicant just met the approval criteria and that applicant's bureau error score was high 475, meaning a large potential for errors in an applicant's credit file that may trigger a credit dispute, additional credit investigation may be necessary, such as obtaining cross bureaus (i.e. pulling credit bureaus and bureau scores from other providers), pulling a tri-bureau, debit bureau or alternative credit evaluation sources. The application may be disapproved or sent for additional review to see if the loan should be declined vs. approved 485. Border applicants with low error scores may be referred for potential approval 480.

B) Bureau Error Alert Service

In another embodiment, consumers may sign up for bureau error alert notification services, where an alert may be triggered if their bureau error score indicated high probability of an error that would adversely impact the consumer. Credit providers could offer this as a value added service to their customers.

C) Credit Bureau Error Reason Codes

The credit bureau error reason codes could be used in concert with the credit bureau error score in the development of specialized credit and customer service treatment strategies for the determination of approvals, declines, the need for additional investigation or customer service action. The credit bureau error reason codes may be an added feature to the bureau error alert notification service to provide the consumer with more information relative to the potential bureau error.

Any of the above-described processes and methods may be implemented by any now or hereafter known computing device. For example, the methods may be implemented in such a device via computer-readable instructions embodied in a computer-readable medium such as a computer memory, computer storage device or carrier signal.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of assessing a credit risk score comprising:
creating training data from historic credit data, wherein the historic credit data includes a credit risk score of a consumer;
developing a first set of tokens from the training data;
analyzing current credit data for the consumer to develop a second set of tokens, wherein the second set of tokens is a subset of the first set of tokens;
using the second set of tokens to develop a quality score that is indicative of a quality of the consumer's credit risk score.

2. The method of claim 1, wherein the historic credit data comprises tradeline information, consumer or business attribute information, public record data credit inquiry data, bureau alert data, or non-tradeline information.

3. The method of claim 1, wherein the quality score comprises a probability distribution or a probability score.

4. The method of claim 1, wherein the quality score comprises a volatility score that predicts variability of the credit risk score over a period of time in the future.

5. The method of claim 4, wherein the volatility score comprises an expected value of the credit risk score's statistical variance over at least one future span of time.

6. The method of claim 1, wherein the quality score comprises an error score that determines a likelihood of occurrence of a credit dispute.

7. The method of claim 6, wherein the quality score comprises an error score that determines whether the dispute will result in a change in the consumer's credit file.

8. The method of claim 1, wherein the quality score comprises a variability score that determines the variability of the consumer or business credit score among credit reporting agencies.

9. The method of claim 1, further comprising combining the quality score with individual consumer data to determine credit risk score stability and consumer dispute potential.

10. The method of claim 1, further comprising using the quality score to develop underwriting rules for credit approval.

11. The method of claim 1 further comprising generating at plurality of reason codes for the quality score.

12. A method of assessing the volatility of a plurality of a credit risk scores comprising:
creating training data from historic credit data, wherein the historic credit data includes data for a plurality of consumers over a plurality of time periods;
predicting a volatility based on the training data;
using the predicted volatility as a quality score for a credit risk score of one or more of the consumers.

13. A method of assessing a credit risk score comprising:
identifying historic credit data, wherein the historic credit data includes a consumer credit risk score of a consumer; and
developing a quality score based on the historic credit data, wherein the quality score comprises a prediction of a volatility of the consumer credit risk score over a period of time.

14. The method of claim 13, wherein the developing a quality score comprises predicting a distribution of the score over a period of time.

15. A method of assessing a credit risk score comprising:
identifying historic credit data, wherein the historic credit data includes a consumer credit risk score of a consumer; and
developing a quality score based on the historic credit data, wherein the quality score comprises a prediction of a variability of the consumer credit risk score among a plurality of agencies.

16. The method of claim 15, wherein the developing a quality score comprises predicting a probability distribution of the credit risk score over a period of time and combining components of the predicted probability distribution to determine the quality score.
